(19) United States
(12) Patent Application Publication
(10) Pub. No.: US 2018/0075362 A1
(43) Pub. Date: Mar. 15, 2018

(54) METHOD FOR INCIDENT DETECTION IN A TIME-EVOLVING SYSTEM

(71) Applicant: NEC Europe Ltd., Heidelberg (DE)

(72) Inventors: Luis Moreira-Matias, Heidelberg (DE); Francesco Alesiani, Heidelberg (DE)

(21) Appl. No.: 15/565,693

(22) PCT Filed: Apr. 14, 2015
(86) PCT No.: PCT/EP2015/058046

§ 371 Date: Oct. 11, 2017

(51) Int. Cl. G06N 7/00; G06N 3/08; G06F 17/18; G06N 99/00; G06F 17/30; G06F 17/11

(52) U.S. Cl. CPC G06N 7/005; G06N 3/084; G06F 17/11; G06N 99/005; G06F 17/30064; G06F 17/18

(57) ABSTRACT

A method for incident detection in a time-evolving system (TOS), having a plurality of objects moving in time and space along predefined paths, is performed in a memory available to a computation device. The method includes, in a step a), providing predictions of at least two system parameters by using for each prediction a different prediction procedure based on observations. In a step b), the predictions are combined to a prediction ensemble. In a step c), the prediction ensemble is corrected based on an abnormal change of the system having occurred, wherein: the abnormal change is detected by monitoring distributions of deviations from the prediction ensemble, and the prediction ensemble is corrected incrementally based on a real-time learning procedure. In a step d), an incident is detected based on a result of step c).

### CROSS-REFERENCE TO PRIOR APPLICATION

This application is a U.S. National Stage Application under 35 U.S.C. §371 of International Application No. PCT/EP2015/058046 filed on Apr. 14, 2015. The International Application was published in English on Oct. 20, 2016 as WO 2016/165742 under PCT Article 21(2).

### FIELD

The present invention relates to a method for incident detection in a time-evolving system, ‘TOS’, said TOS comprising a plurality of objects moving in time and space along predefined paths, preferably cars moving in streets of a city.

The present invention further relates to a system for incident detection in a time-evolving system, ‘TOS’, said TOS comprising a plurality of objects moving in time and space along predefined paths, preferably cars moving in streets of a city, wherein said system comprising one or more computation devices.

Although applicable to any kind of time-evolving system the present invention will be described with regard to road transport systems, in particular traffic systems.

### BACKGROUND

Today in urban areas the population is growing on a very high rate causing a lot of traffic resulting in many traffic congestions. Such growth is pressuring the transportation industry on finding solutions to maintain sustainable levels of urban mobility without imposing large-scale investments, for example to build new freeways or to renew an entire bus fleet or the like. Such traffic congestion can be divided in two types: The first one (i) regular, which means that traffic congestion happens on a regular basis within a given periodicity and/or time stamp. These regular congestions are for example a traffic jam on every Friday's evening peak-hour. The second type (ii) is a stochastic one, which is caused by an abnormal event, for example car accidents, construction activities, fast weather changes, etc.. These abnormal events are often defined or denominated as incidents as disclosed in the non-patent literature of S. Tang and H. Gao, “Traffic-incident detection-algorithm based on nonparametric regression,” IEEE Transactions on Intelligent Transportation Systems, vol. 6, no. 1, pp. 38-42, 2005. After such incidents or occurrences the traffic flow usually suffers a disruption which usually results on an unexpected behavior, for example large travel delays.

Conventional traffic systems automatically try to detect such incidents. For example in the non-patent literature of A. Karim and H. Adeli, “Incident detection algorithm using wavelet energy representation of traffic patterns,” Journal of Transportation Engineering, vol. 128, no. 3, pp. 232-242, 2002 a two-stage single-station freeway incident detection model is proposed based on advanced wavelet analysis and pattern recognition techniques. The wavelet analysis is used to denoise, cluster and enhance the raw traffic data, which is then classified by a radial basis function neural network.

In the non-patent literature of M. Lippi, M. Bertini, and P. Frasconi, “Short-term traffic flow forecasting: An experimental comparison of time-series analysis and supervised learning,” IEEE Transactions on Intelligent Transportation Systems, vol. 14, no. 2, pp. 871-882, 2013 a method for short-term traffic flow forecasting is disclosed. The method disclosed therein uses time series analysis as well as Kalman-filters.

In the non-patent literature of S. Tang and H. Gao, “Traffic-incident detection-algorithm based on nonparametric regression,” IEEE Transactions on Intelligent Transportation Systems, vol. 6, no. 1, pp. 38-42, 2005 a non-parametric regression algorithm for forecasting traffic flows and its application in automatic detection of traffic incidents is disclosed. This conventional method is constructed based on the searching method of nearest neighbors for a traffic-state vector.

The non-patent literature of B. Williams and L. Hoel, “Modeling and forecasting vehicular traffic flow as a seasonal ARIMA process: Theoretical basis and empirical results,” Journal of Transportation Engineering, vol. 129, no. 6, pp. 664-672, 2003 uses a seasonal version of the autoregressive integrated moving average ARIMA for forecasting vehicular traffic flow.

In CN 103903452 A a short-term traffic flow prediction method is disclosed.

In CN 103745602 A a method for traffic flow prediction is disclosed based on sliding window averages.

In CN 102682345 A a method for predicting traffic flow is based on quick learning neural network with double optimal learning rates.

In CN 102693633 B a method for short-term traffic flow prediction is shown using a weighted combination. The method comprises the steps of organizing historical traffic flow data by utilizing a dynamic clustering algorithm, performing short-term traffic flow prediction by using an improved nearest neighbor non-parametric regression method, performing the short-term traffic flow prediction by taking a cluster which is the most similar to a current point in a historical database as a training sample of a fuzzy neural network and using a fuzzy neural network model and determining the weight of a combined prediction method according to a prediction error of the improved nearest neighbor non-parametric regression method and the fuzzy neural network model in the last time bucket and outputting a final prediction result in a weighted combination way. The traffic flow in the last time bucket and the traffic flow of related turning in an upstream road junction are taken into account, the training sample of a fuzzy neural network is optimized and the final prediction result is output in the weighted combination way, so that the short-term traffic flow prediction accuracy in real time performance are improved.

### SUMMARY

In an embodiment, the present invention provides a method for incident detection in a time-evolving system (TOS), comprising a plurality of objects moving in time and space along predefined paths, which is performed in a memory available to a computation device. The method includes, in a step a), providing predictions of at least two system parameters by using for each prediction a different prediction procedure based on observations. In a step b), the at least two predictions are combined to a prediction ensemble. In a step c), the prediction ensemble is corrected based on an abnormal change of the system having occurred, wherein: the abnormal change is detected by monitoring distributions of deviations from the prediction ensemble, and the prediction ensemble is corrected incrementally based on a real-time learning procedure. In a step d), an incident is detected based on a result of step c).

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a conventional method for incident detection and traffic prediction;

FIG. 2 shows an embodiment of a method according to the invention,

FIG. 3 shows a result of a part of a method according to an embodiment of the present invention;

FIG. 4 shows an example of a result of a method according to the invention;

FIG. 5 shows statistics of a result of a method according to an embodiment of the present invention;

FIG. 6 shows a parameter setting used in an embodiment of the invention;

FIG. 7 shows results on an evaluation according to an embodiment of the invention; and

FIG. 8 shows a result of a part of a method according to an embodiment of the present invention;

### DETAILED DESCRIPTION

The inventors have recognized that conventional methods and systems for automatic incident detection have a poor detection accuracy and need a high-demand of real-time traffic information causing high computational and sensorical costs. Another problem recognized by the inventors is to detect the incident early enough to restore a smooth traffic flow, for example through advanced traveler information system of intelligent transport systems, like dynamic speed limits, lane allocations or the like to avoid or at least reduce the building of a traffic jam due to an incident.

The aforementioned problems are solved by one or more of the embodiments of the present invention.

At least one embodiment of the present invention comprises a method for incident detection in a time-evolving system, ‘TOS’, said TOS comprising a plurality of objects moving in time and space along predefined paths, preferably cars moving in streets of a city, the method performed in a memory available to a computation device, comprising the steps of:
a) Providing predictions of at least two system parameters by using for each prediction a different prediction procedure based on observations,
b) Combining said at least two predictions to a prediction ensemble,
c) Correcting the prediction ensemble when an abnormal change of said system occurred, wherein
   an abnormal change is detected by monitoring distributions of deviations from the prediction ensemble, and wherein
   the prediction ensemble is corrected incrementally based on a real-time learning procedure, and
d) Detecting an incident based on the result of c).

Further at least one embodiment of the present invention comprises a system for incident detection in a time-evolving system, ‘TOS’, said TOS comprising a plurality of objects moving in time and space along predefined paths, preferably cars moving in streets of a city, wherein said system comprising one or more computation devices, said computation device or devices comprising
a) Prediction means adapted to provide predictions of at least two system parameters of said TOS by using for each prediction a different prediction procedure based on observations,
b) Combining means adapted to combine said at least two predictions to a prediction ensemble,
c) Correcting means adapted to correct the prediction ensemble when an abnormal change of said system occurred, wherein an abnormal change is detected by monitoring distributions of deviations from the prediction ensemble, and wherein the prediction ensemble is corrected incrementally based on a real-time learning procedure, and
d) Detecting means adapted to detect an incident based on the result provided by said correcting means.

At least one of the embodiments may enable higher accuracy on traffic and event prediction, which may be achieved by monitoring the prediction residuals to then adapt its output values accordingly.

Further features, advantages and further embodiments are described or may become apparent in the following:

For detecting an abnormal change a Page-Hinkley test may be used using as cumulated variable the cumulated difference between past observations and their mean till the current moment. A Page-Hinkley test may be implemented easily and may provide a reliable detection of an abnormal change.

Said distributions may use an allowed change parameter, ‘ACP’, representing a magnitude of an allowed change. This may enable a fine-grained tuning for determining an incident and may enhance flexibility since the method can be adapted to needs, for example of a bus operator or the like.

A corresponding ACP may be used of each system parameter. This may enable a new more fine-grained tuning, for example to the need of an operator.

A neuronal network, preferably a single layer neural network, preferably a Perceptron's neuron, may be used for correcting the prediction ensemble. This may enable a higher precision, e.g. a more precise detection of peaks and/or valleys may be enabled.

Said neuronal network may use a delta rule procedure based on a backpropagation procedure for feedforward neural networks. This may enable a reliable learning method for updating predictions incrementally. Further slopes of peaks and/or valleys of observations may be rapidly captured.

One prediction procedure may be based on the Autoregressive Integrated Moving Average, ‘ARIMA’, and another prediction method may be based on the Holt-Winters Exponential Smoothing, ‘ETS’. This may provide different time series analysis methods which may provide a higher precision for predictions.

The combined prediction, the prediction ensemble, may be provided by weighted combining of results of said at least two methods. This may enable a smoothed prediction.

Said prediction ensemble may be based on past observations within a certain time window wherein said time window is sliding in time upon new observations. This may provide a sliding average taking into account recent changes and neglecting past observations without said time window.

At least two different time windows may be used having different window size. This may enable a higher precision and may guarantee an enhanced performance on most of the road-based scenarios of a time-evolving system. For example two distinct windows or window histograms may be used on two layers. One layer may keep the original time series aggregation level while the second one may employ the desired size of the predictive horizon which may be higher and which may be a multiple of the first one. This may then enable to generate window histograms for any type of horizon with a periodicity of the size of the first layer for a time horizon of the size of the second layer.

Whenever c) is performed monitoring distributions of deviations from the predictive ensemble may be reinitialized. The Page-Hinkley test may be restarted. This may enable a higher position since then the consequences of the occurred incident are considered during the next time steps.

A filtering may be performed for said predictions resulting in a single zero-one signal representing an incident. This may enable an easy evaluation if an incident has occurred or not based on said signal.

Said filtering may be performed by comparing each prediction with a corresponding threshold and when each prediction triggers its corresponding threshold then an incident is detected. This may enhance the flexibility since each prediction is provided with a corresponding threshold, i.e. for different predictions different thresholds can be used.

Additionally a correlation threshold between the at least two predictions may have to be triggered to detect an incident. Said predictions may be the most recent ones and/or an incident has been detected at a prior time point. The prior time point may be the last time point prior to the actual time point. This may enable a good precision for incident detection by taking into account also correlations between at least two predictions.

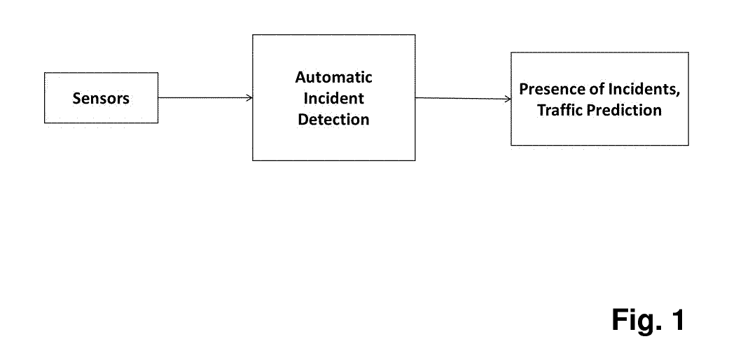

FIG. 1 shows a conventional method for incident detection and traffic prediction.

FIG. 1 shows principal steps of a conventional method for traffic prediction. Sensors transmit their data to an automatic incident detection which detects whether an incident has occurred or not and then the presence of incidents as well as traffic prediction is provided.

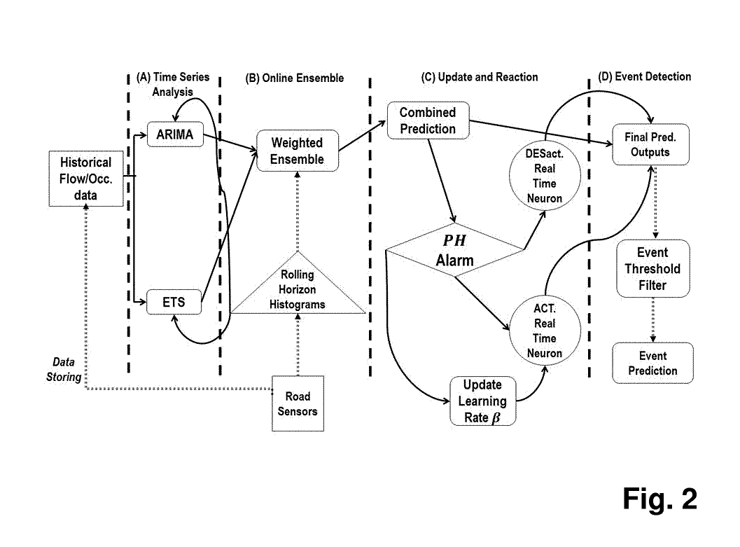

FIG. 2 shows an embodiment of a method according to the invention.

In FIG. 2 an embodiment is shown comprising four different steps (A)-(D). Step (A) provides flow/occupancy prediction to time series analysis. Step (B) provides an online ensemble to aggregate multiple learning models into a single prediction output. Step (C) provides an update and reaction to correct the prediction regarding the early detection of incidents and step (D) provides event detection where signals are transformed into a zero-one signal, i.e. no-event or event, regarding the incident-based thresholds being previously defined.

In the following these steps (A)-(D) are in detail discussed:

Flow/occupancy prediction using time series analysis according to step (A) is described:

In the following two of the conventional methods for a traffic flow prediction autoregressive integrated moving average ARIMA and the Holt-Winters-exponential smoothing ETS procedures are used in the following way:

Let F={f₁, . . . , f₅} and O={o₁, . . . , oₜ} be the averaged traffic flow and the lane occupancy rates on a given road section aggregated by periods of p-minutes, respectively, measured till the time instant t. A first goal is now to predict the future short-term values of these series, i.e. fₜ₊₁, oₜ₊₁.

To achieve this goal said ARIMA and ETS methods, as formulated below are implemented.

The AutoRegressive Integrated Moving Average Model (ARIMA) as disclosed in the non-patent literature of G. Box, G. Jenkins, and G. Reinsel, “Time series analysis”, Holden-day San Francisco, 1976 is a well-known methodology to both model univariate time series. The ARIMA main advantages when compared to other algorithms are two:
1) it is versatile to represent very different types of time series: the autoregressive (AR) ones, the moving average ones (MA) and a combination of those two (ARMA);
2) on the other hand, it combines the most recent samples from the series to produce a forecast and to update itself to changes in the model. A brief presentation of one of the simplest ARIMA models (for non-seasonal stationary time series) is enunciated below.

In ARIMA, the future value of a variable is assumed to be a linear function of several past observations and random errors. It is possible to formulate it as

fₜ=κ₀+φ₁fₜ₋₁+φ₂fₜ₋₂+ . . . +φₚfₜ₋ₚ+εₜ−ε₁εₜ₋₁−κ₂εₜ₋₂− . . . −κ_{q}ε_{t-q}

where fₜ and {εₜ, εₜ₋₁, εₜ₋₂, . . . } are the actual value at time period t and the error terms (i.e. noise) observed in the past signal, respectively; φₗ (l=1, 2, . . . , p) and κₘ (m=0, 1, 2, . . . , q) are the model parameters/weights while p and q are positive integers often referred to as the order of the model. Both order and weights can be inferred from the historical time series using both the autocorrelation and partial autocorrelation functions as proposed by Box and Jenkins in the non-patent literature of G. Box, G. Jenkins, and G. Reinsel, “Time series analysis”, Holden-day San Francisco, 1976.

The ETS relies on a smooth combination of previous values of a given time series of interest where the weights of each term decrease exponentially throughout the time dimension. Similarly to ARIMA, it presents a recursive definition by including the previous predictions in their model. Hereby the simplest ETS formulation (i.e. NN) is introduced. However, there are a total of 12 possible ETS models (which are described in detail through Section 2 in the non-patent literature of R. Hyndman, A. Koehler, R. Snyder, and S. Grose, “A state space framework for automatic forecasting using exponential smoothing methods,” International Journal of Forecasting, vol. 18, no. 3, pp. 439-454, 2002).

Let sₜ be the smoothed value on t (i.e. the model prediction for the time instant t+1) defined as

sₜ+α·fₜ+(1−α)·sₜ₋₁

where 0<α<1 is a smoothing factor (i.e. model's parameter). α works as a forgetting factor which aims set the reactiveness of the method to bursty changes. However, its selection may be highly dependent on the model in place (which can be determined automatically, aside with the ARIMA's parameters and model, as further discussed below).

Now the Online Ensemble according to step (B) is described.

Here the two methods are mixed into a single prediction through an online weighted ensemble method. This method monitors their recent performance on the prediction task using a sliding window of fixed size. Then, their performance (e.g., a value ranged between 0 and 1) is used to do a weighted average of their output—which results on the desired combination. Such combination may result on a smoothed prediction—which will not capture the typical bursty characteristics of a flow signal during a bottleneck generation. Moreover, this schema standalone may be only capable of producing outputs through fixed timespans (which are defined along with the time series aggregation level).

In case of such limitations, sliding window histograms are used to overcome these limitations: Two distinct histograms on two layers (p and P) are maintained. One layer (layer 1) keep the original time series aggregation level while the second one employs the desired size of the predictive horizon, which may be higher and a multiple of the first one. Consequently, this may allow to generate histograms for any type of horizon with a periodicity of p minutes for an time horizon of P minutes. This step (B) increases largely the predictive possibilities of the initial methods by guaranteeing a good performance on most of the road-based scenarios.

In more detail one of the main issues on working with traffic flow data is the noise within as disclosed in the non-patent literature of S. Tang and H. Gao, “Traffic-incident detection-algorithm based on nonparametric regression,” IEEE Transactions on Intelligent Transportation Systems, vol. 6, no. 1, pp. 38-42,2005, and as disclosed in the non-patent literature of A. Karim and H. Adeli, “Incident detection algorithm using wavelet energy representation of traffic patterns,” Journal of Transportation Engineering, vol. 128, no. 3, pp. 232-242,2002.

One way to smooth such noise is to employ larger aggregation period by averaging the existing measures on larger timespans of size P>>p. However this causes:
(1) information loss (as it may not be able to adequately model a true peak due our previous smoothing) and
(2) dead periods due to the dependence to the aggregation level in place. For instance if P=30 minutes, one will only be able to build up a prediction each 30 minutes because of having to stick to bin boundaries defined on your historical histogram time series).

To handle this type of problems an incremental discretization (e.g. as disclosed in the non-patent literature of L. Moreira-Matias, J. Gama, M. Ferreira, J. Mendes-Moreira, and L. Damas, “On predicting the taxi-passenger demand: A real-time approach,” in Progress in Artificial Intelligence, ser. LNCS. Springer, 2013, vol. 8154, pp. 54-65) may be used:. A series count fₜ in an interval [t, t+P] will be very similar to the count fₜ₊₁ in the interval [t+p, t+P+p] (as much as p˜0). This can be formulated in the following way:

$${f}_{t + 1} = ( {f}_{t} \cdot \vert {f}_{t} \vert + {f}_{[ t + P , t + P + p ]}^{′} - {f}_{[ t , t + p ]}^{′} ) \cdot \frac{1}{\vert {f}_{t} \vert}$$

where f′ represents both the continuous event count on the first p-minutes of the interval [t, t+P] and on the p-minutes immediately after the same period. Then advantage of the additive characteristics of any histogram time series is used to rapidly calculate a new series of interest maintaining two aggregation levels/layers: P and p.

Time series analysis methods are known to be highly effective on dealing with short-term prediction horizons as disclosed in the non-patent literature of B. Williams, P. Durvasula, and D. Brown, “Urban freeway traffic flow prediction: application of seasonal autoregressive integrated moving average and exponential smoothing models,” Transportation Research Record: Journal of the Transportation Research Board, vol. 1644, no. 1, pp. 132-141,1998 and in the non-patent literature of M. Lippi, M. Bertini, and P. Frasconi, “Short-term traffic flow forecasting: An experimental comparison of time-series analysis and supervised learning,” IEEE Transactions on Intelligent Transportation Systems, vol. 14, no. 2, pp. 871-882,2013. However, the selection of the best algorithm/model is usually highly dependent on human expertise. Moreover, a model may be superior on some periods of the day while others may present higher performance under specific conditions, e.g. traffic jam. To handle with such variability, an online ensemble learning schema is employed along with the abovementioned rolling horizon histograms.

One of the models of this type is the weighted ensemble (e.g. as disclosed in the non-patent literature of L. Chen and C. Chen, “Ensemble learning approach for freeway short-term traffic flow prediction,” in IEEE International Conference on System of Systems Engineering. IEEE, 2007, pp. 1-6 and in the non patent literature of “Predicting taxi-passenger demand using streaming data,” IEEE Transactions on Intelligent Transportation Systems, vol. 14, no. 3, pp. 1393-1402, 2013). It is presented as follows.

Considering M={M_{,}M₂, . . . , M₁} to be a set of l models (i.e. hereby, l=2) of interest to model a time series and G={g₁, t, . . . , glt} to be the set of forecasted values for the next period on the interval t by those models. The ensemble forecast Eₜ is obtained as

$${E}_{t} = {\sum }_{i = 1}^{l} \frac{{G}_{it} \cdot ( 1 - {ρ}_{i} )}{ϒ} , ϒ = {\sum }_{i = 1}^{l} ( 1 - {ρ}_{i} )$$

where pix represents the error of the model Mᵢ in the periods comprised on the time window [t−H, t]. H may be a user-defined hyper-parameter to define the window size. As the information is arriving continuously of the next periods t, t+1, . . . , the window will also slide to determine how the models are performing in the last H periods. To calculate such error, a normalized version of the Symmetric Mean Percentage Error, i.e. sMAPEₙ, is employed. Consequently ρᵢ=sMAPEₙ(i)² is computed using the following formulae:

$${sMAPE}_{n} ( i ) = \frac{1}{H} \cdot {\sum }_{j = t - 1}^{t - H} \frac{\vert {g}_{i , j} - {f}_{j} \vert + c}{{g}_{i , j} + {f}_{j} + c}$$

where sMAPEn(i) is the error produced by the model Mᵢ and c is a smoothing constant to deal with low values (i.e. hereby, c=1 is employed). Notwithstanding its validity, this schema model may require a good performance of at least one predictive model on every time instant t to produce outputs similar to the real ones.

In the subsequent section, it is described how such issue with a pure incremental learning schema can be tackled.

In the following the Update and Reaction procedure according to step (C) is described:

As mentioned in the previous section, the incidents provoke a disruption on the usual traffic flow pattern. Whenever such disruption happens suddenly (e.g. due to a car accident), the system must react accordingly as the underlying model will not explain the current behavior anymore. Time series analysis methods are known by their reactivability. However, bursty peaks/valleys may not be easy to predict. Hence, this is one of the main reasons behind the failure of many of the existing automatic incident detection AID algorithms.

To tackle this an incremental change detection method is employed, here the so-called Page Hinkley test. This test monitors the evolution of the probability distribution of a given variable, storing cumulative changes which may trigger an alarm after accumulating sufficient evidences that the concept, i.e. the probability distribution previously learnt/handled is not in place anymore, i.e. concept drift.

In the following said Page Hinkley test is used to monitor the residuals distribution in order to guarantee that the prediction obtained through the steps (A) and (B) is reliable enough to perform AID.

Whenever this alarm is triggered, an update neuron is activated. This update neuron is inspired on Perceptron, a single layer neuronal network. However, it aims to update the prediction output directly (and not any network link's weights). Then, this neuron uses the delta rule (originally part of the Backpropagation Algorithm, a popular learning method for Feedforward Neural Networks) to update the predictions incrementally. When active, it reuses just a part (i.e. the learning rate β, a parameter between 0 and 1) of the most recent residual to add it directly to the prediction output. By doing it so, rapidly capture the true slope of peaks/valleys is expected in order to anticipate the nature of the event in place. Ultimately, it increases the incident prediction capabilities by stretching its reactiveness to the limit.

Whenever the change detection alarm is triggered, the Page Hinkley test is restarted. If an alarm is triggered while a Neuron is active, the learning rate is increased accordingly. On the other hand, a consecutive number of periods without any accumulated divergence will result on the deactivation of the real-time update neuron.

In more detail the predictive framework described above in steps (A) and (B) possesses its own mechanism to update itself using the novel series terms. However, those may not be enough to react on-time to a change on the underlying learning model required to perform such prediction (e.g. a smooth flow series which drops abruptly after a car crash). Such reaction time is inter alia key for AID. To overcome such limitation, a two fold incremental learning framework which aims to correct the prediction values whenever they are failing to explain the nature of the time series as already described above is used. The first problem is to define what is a satisfactory performance of the model. To define said performance said Change Detection method in form of the Page-Hinkley (PH) test as disclosed in the non-patent literature of E. Page, “Continuous inspection schemes,” Biometrika, vol. 41, no. 1/2, pp. 100-115, 1954 is used. Said test considers a cumulative variable m_{T}, defined as the cumulated difference between the observed values and their mean till the current moment. Hereby, the evolution of the prediction residuals are monitored with said test, i.e. rₜ=fₜ−Eₜ, which leads to the following definition

$${m}_{T} = {\sum }_{y = 1}^{T} ( \vert {r}_{t} \vert - {\overline{r}}_{T} - δ ) , {\overline{r}}_{T} = {\sum }_{y = 1}^{T} \frac{\vert {r}_{t} \vert}{T}$$

where δ corresponds to the magnitude of changes that are allowed (e.g.. two user defined parameters for flow and occupancy, δ_{f}, δₒ). The output of the PH test, i.e. PH_{T} can be obtained as follows

PH_{T}=m_{T}−min(mₜ, t=1 . . . T)

whenever PH_{T}>λ, it throws an alarm and resets the test variables. λ depends on the admissible false alarm rate on the change of our residual's distribution (again, λ is decomposed e.g. on two user-defined parameters for flow and occupancy, i.e. λ_{f}, λₒ)).

The alarm triggered by the PH_{T} can be translated on a significant change on residuals p.d.f. (i.e. the right tail is going considerably thicker) which is provoked by a change on concept embedded on our learning model. This absence of concept may fade the previous mid-term learning schema into something more reactive. To do it so, a single Perceptron's neuron as disclosed in the non-patent literature of F. Rosenblatt, “The perceptron: a probabilistic model for information storage and organization in the brain.” Psychological review, vol. 65, no. 6, p. 386, 1958 is employed to enable the system to learn incrementally on a fast rate. This neuron aims to correct the prediction outputs based on the newest residual available. Such reactive learning behavior is inspired on the Delta Rule DR as disclosed in the non-patent literature of G. Stone, “An analysis of the delta rule and the learning of statistical associations,” Parallel distributed processing: Explorations in the microstructure of cognition, vol. 1, pp. 444-459, 1986, which is part of one of the most well-known learning schemas for Feedforward Neutral Networks FNN: the BackPropagation algorithm as disclosed in the non-patent literature of J. McClelland, D. Rumelhart, P. R. Group et al., “Parallel distributed processing,” Explorations in the microstructure of cognition, vol. 2, 1986. This procedure is formally described below.

Let Eₜ be the predicted value while rₜ₋₁ stands for the newest residual available. After been triggered by PH_{T}, this neuron updates Eₜ as follows

E′ᵢ=Eₜ+Δ_{E}_{ₜ}:Δ_{E}_{ₜ}=β·rₜ₋₁

where the starting value of β, i.e. β₀, is an user-defined parameter. To improve the model ability to react, the learning rate β may also be updated: if any alarm is triggered by the PH test while the neuron is activated, the β value is updated as β′=min(1.2·β, 1). This variant of the DR is denominated Exponential DR and it is commonly used to model floating concepts or their absence (e.g. concept drift on travel time prediction in as disclosed in the non-patent literature of L. Moreira-Matias, J. Gama, J. Mendes-Moreira, and J. Freire de Sousa, “An incremental probabilistic model to predict bus bunching in real-time,” in Advances in Intelligent Data Analysis XIII, ser. LNCS, Springer International Publishing, 2014, vol. 8819, pp. 227-238. Finally, the neuron is deactivated if there are x consecutive periods for whose the in equation PH_{T}≦λ is true.

Note that, despite the rolling horizon additive approach described in step (B) to produce predictions each p minutes using an aggregation level P>p minutes, the residuals as well as all the update rules described throughout this section of step (C) follow the largest periodicity, i.e. P. Even so, this framework may be designed for this specific context, where an incident is usually characterized by a sudden change on traffic flow parameters as disclosed in the non-patent literature of S. Tang and H. Gao, “Traffic-incident detection-algorithm based on nonparametric regression,” IEEE Transactions on Intelligent Transportation Systems, vol. 6, no. 1, pp. 38-42, 2005, and as disclosed in the non-patent literature of A. Karim and H. Adeli, “Incident detection algorithm using wavelet energy representation of traffic patterns,” Journal of Transportation Engineering, vol. 128, no. 3, pp. 232-242, 2002. By doing so, this schema outputs a single prediction value employing a real-time learning process. Then, these flow/occupancy rate predictions are inputted, along with historical data, to the event detection framework. This latter is described below.

In the following an Event Detection procedure according to step (D) is described:

This step (D) comprises on filtering both the flow and the occupancy prediction obtained through the previous three steps (A)-(C) into a single zero-one signal, i.e. no-event/event. The definition of incident may vary from scenario to scenario (e.g. a traffic jam in Heidelberg, Germany may correspond to the normal flow pattern in Los Angeles, US). Yet, two basic high/low-pass filters along with a simple correlation schema may be used. The filters/correlation schema use simple thresholds which, when satisfied by both measurements (flow/occupancy), triggers an incident alarm.

In more detail typically, AID systems which employ traffic flow prediction models rely on fixed thresholds to predict the incident's occurrence beforehand. The same approach is taken to build “3D-flow”. Let Θ(t) be a binary event time series. It can be computed as follows

$$Θ ( t ) = \{ \begin{matrix}1 & if {f}_{t} < {ϕ}_{f} {o}_{t} > {ϕ}_{o} corr ( {f}_{t , H} , {o}_{t , H} ) < ϑ \\ 1 & if {f}_{t} < {ϕ}_{f} {o}_{t} > {ϕ}_{o} Θ ( t - 1 ) = 1 \\ 0 & otherwise .\end{matrix}$$

where φ_{f}, φ₀, θ are user-defined parameters for the flow, occupancy an correlation coefficient thresholds, respectively. f_{t,H}, o_{t,H} stands for the H most recent data points on each time series. Then, the AID framework can be defined, i.e. Θ′, using the same schema by replacing the latest series terms fₜ, oₜ by the predictive model's output. Efₜ, Eoₜ, and by increasing/decreasing the thresholds φ_{f}, φₒ on 10% of their original value, respectively.

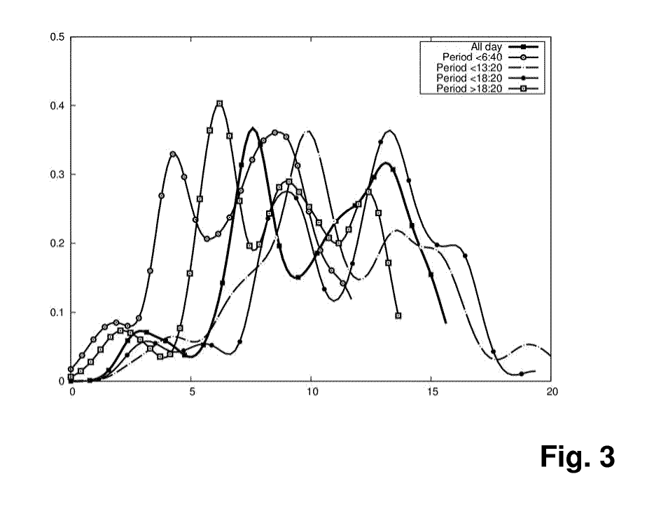

This entire framework was validated on real-world case study, which is described in the subsequent sections together with FIG. 3-8.

The following FIGS. 3-8 refer to an application of an embodiment of the present invention using data collected through a traffic monitoring system of a major freeway from an Asian country.

This system both collects and broadcasts traffic-based measurements in real-time with distinct temporal granularities (depending on the type of sensor's installed on each lane). Each sensor measures traffic flow, lance occupancy rate and instantaneous vehicle's speed. Yet, just the data of the first two was used for this study. The largest time granularity of this data collection system (p=5 minutes) was used to normalize all the collected time series. This step aims to establish a common comparative testbed for the different sections, independent on its lane number or distinguish main lanes from input/output ramps flows.

This dataset used data collected from 106 sensors which includes both freeway's transit directions. Its total length is roughly 20 km while its sensors are deployed each 500. This data was collected through 3 non-consecutive weeks.

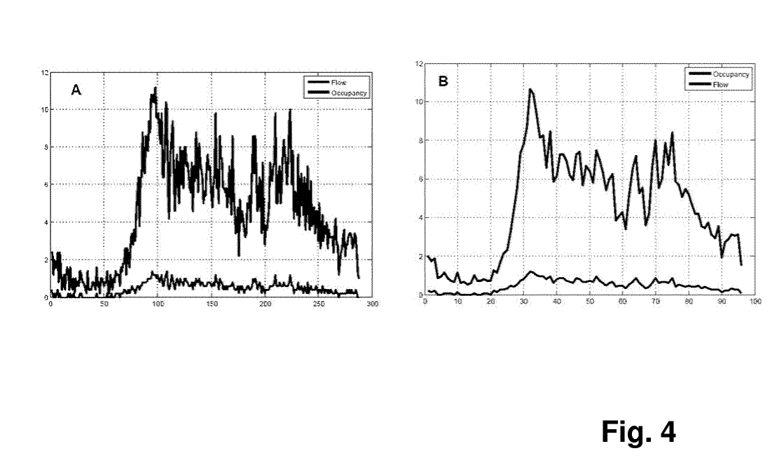

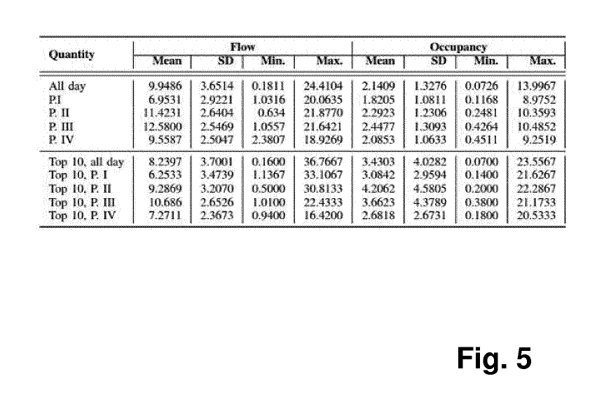

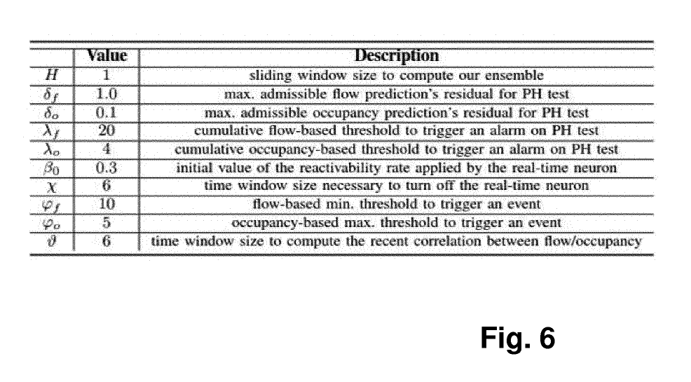

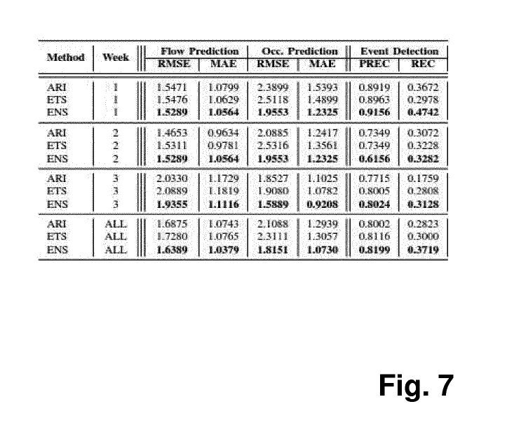

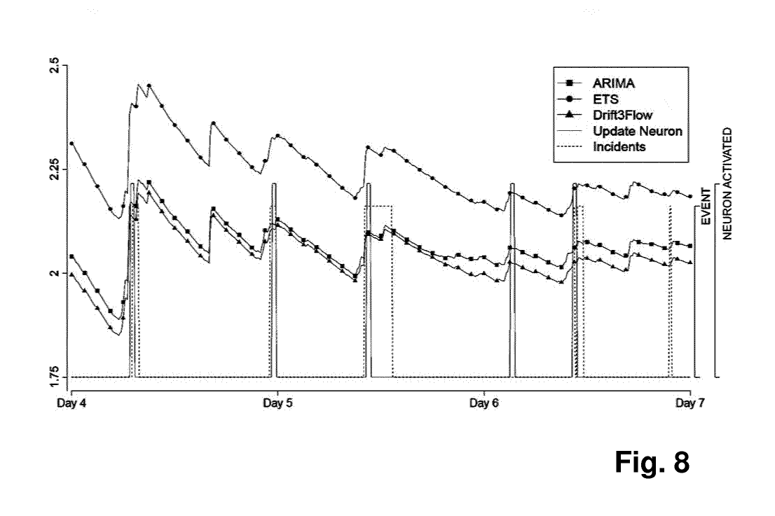

In detail with regard to the figures FIG. 3 shows a result of a part of a method according to an embodiment of the present invention, FIG. 4 shows an example of a result of a method according to the invention, FIG. 5 shows statistics of a result of a method according to an embodiment of the present invention, FIG. 6 shows a parameter setting used in an embodiment of the invention, FIG. 7 shows results on an evaluation according to an embodiment of the invention and FIG. 8 shows a result of a part of a method according to an embodiment of the present invention.

The online ensemble method enunciated in step (B) considers two aggregation levels, i.e. p and P. As preprocessing task, the second layer of aggregations was defined as P=15 minutes. FIG. 4 exhibits the smoothing effect of including these two-layer schema (p and P on the parts A and B) due to the continuous discretization of our time series. FIG. 3 illustrate five sample-based probability distribution functions obtained using a (gaussian) kernel density estimator over all the flow measurements available one global and four specific for each of the considered timespans (divided by Periods I-IV, identified by the same display order as FIG. 3 legend). FIG. 5 includes descriptive statistics on the dataset. The top 10 sensors regarding the number of observed incidents were analyzed. As it is observable, the occupancy rate is higher in these sensors. Not surprisingly the most critical period is the morning peak, comprised between 6:40 and 13:20.

Three distinct predictive methods are used here: ARIMA (ARI), Holt-Winters Exponential Smoothing (ETS) and the hereby proposed 3D-flow. All three used the same Event Detection framework described in step (D). On the top of the sensor-based division described on the previous section, it is also assumed statistical independence between the data of each one of the three weeks (as they are non-consecutive). Consequently, it resulted on a total of 318 experiments (106 sensors×3 weeks).

The parameter setting employed is described in FIG. 6. The ARIMA model (p, d, q values and seasonality) was firstly set (and updated each 24 h) by learning/detecting the underlying model running on the historical time series curve of each stand during the first two days of each week. For that, an automatic time series function was employed, i.e. auto-arima. The weights/parameters for each model are specifically fit for each period/prediction using the function arima from the built-in R package [stats]. The ETS model (trend and seasonality) are automatically estimated for each and every prediction using the function ets, along with the a weight. The automatic forecast procedure followed by this function is described in the non-patent literature of R. Hyndman, A. Koehler, R. Snyder, and S. Grose, “A state space framework for automatic forecasting using exponential smoothing methods”, International Journal of Forecasting, vol. 18, no. 3, pp. 439-454, 2002. Then, the resulting model is used by the function forecast. The functions ets, auto-arima and forecast are part of the R package [forecast] in the non-patent literature of K. Yeasmin and J. Rob, Automatic Time Series Forecasting: The forecast Package for R, 1999, Online available: http://oai.repec.openlib.org.

The evaluation of these experiments were performed on two distinct dimensions; (1) numerical prediction and (2) event detection. In (1), Root Mean Squared Error (RMSE) and Mean Absolute Error (MAE) as evaluation metrics are used. On the other hand, Precision (PRE) and Recall (REC) as the two main evaluators are employed. These metrics are e.g. disclosed in sections 5.7-5.8 in the non-patent literature of I. Witten and E. Frank, “Data Mining: Practical machine learning tools and techniques”, Morgan Kaufmann, 2005. The results were aggregated using a weight average of these metrics, where each sensor's weight is equivalent to the total number of events that they experienced.

The results are presented in three distinct folds: FIG. 7 presents the aggregated results for all the considered weeks. FIG. 8 introduces an time-evolving evaluation of the three methods hereby presented regarding the flow prediction task. It also illustrates its evolution from sensor/weeks with a low-incident rate to the higher ones. The averaged computational time of each individual series term prediction was 15 seconds.

On a first glance, the high number of parameters (ten) may appear as a major drawback. However, just three of them may be adapted for different case studies due to their paper on the learning process: H, β₀ and x. φ_{f}, φₒ and θ address the definition of incident, which is something that must be known before carrying out any supervised learning task. The parameters of the PH test (δ_{f}, δₒ, λ_{f}, λₒ) follow the same logic, addressing the sensibility of the system of the embodiment to divergences on the residual's p.d.f. It is translated on setting the reactivability of our method which is highly dependent on the AID's application scenarios (e.g. dynamic lane selection or just variable message signs). Yet another issue uncovered by FIG. 7 is the low recall values, which indicate a significant percentage of false positive alarms.

However, this is an characteristic common to this type of approach taken by these flow prediction methods to the AID problem as disclosed in the non-patent literature of S. Tang and H. Gao “Traffic-incident detection-algorithm based on nonparametric regression”, IEEE Transactions on Intelligent Transportation Systems, Vol. 6, No. 1, pp. 38-42, 2005. By being purely deterministic, this model does not account distinct risk levels for different error types—which may also differ from AID's applicational task. Yet, the method of the embodiment outperformed the current conventional prediction methods on this particular problem—which is well illustrated by FIG. 8. Its adaptive characteristics (i.e. incrementality) are key to do so. By taking a 100% non-parametric approach to this task, the method of the embodiment gets some sort of freedom to react earlier to changes on the flow/occupancy signal. Such approach may explain its success on road sections with high-incident rate.

In summary at least one embodiment described herein may provide far better results than conventional or traditional methods for flow prediction-based automatic incident detection. At least one embodiment described herein enables a high accuracy for example on traffic and event prediction. This may be accomplished by monitoring the predictions residuals and then adapt its output values accordingly.

At least one embodiment enables a change detection and reaction framework which is described in FIG. 2, step (C) providing a mechanism or procedure built over an accurate prediction framework being able to anticipate and avoid low-performance periods, for example periods where the predicted flow and/or occupancy outputs are sufficiently far away from the real ones. The procedure may comprise the steps of incrementally and monitoring the residual distribution to trigger an update mechanism which is for example inspired by individual neurons of the Perceptron type.

The incrementally monitoring step may be built over a framework able to produce accurate time-evolving predictions over time. An online ensemble framework may be employed together with a rolling horizon histogram scheme which may be replaced by different one given by same guarantees.

A further embodiment may provide a method for full automatic incident detection comprising the following steps:

1) Multiple Predictions of the traffic measures (flow and occupancy) based on the current and past measures; where each prediction uses a specific model (e.g. ARIMA, ETS) that is learned online
2) Ensemble the predictions using error-based weights;
3) Roll the time series histograms to produce novel mixes/predictions with the shortest periodicity possible;
4) Continuously monitor the prediction residual's distribution through a Change Detection method.
5) Once a concept drift alarm is triggered by our monitoring framework (step 1), a correction mechanism on the prediction's value must be activated. This update mechanism is inspired on the learning schema using by a single Perpetron's neuron.
6) Detection of traffic incident based on predicted measures.

At least one of the embodiments may improve automatic incident detection.

At least one embodiment described herein may be used together with a highway monitoring system for at least one of traffic flow prediction, traffic analytics and traffic prediction.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for incident detection in a time-evolving system (TOS) comprising a plurality of objects moving in time and space along predefined paths, the method being performed in a memory available to a computation device, the method comprising:
a) providing predictions of at least two system parameters by using for each prediction a different prediction procedure based on observations,
b) combining the at least two predictions to a prediction ensemble,
c) correcting the prediction ensemble based on an abnormal change of the system having occurred, wherein:
the abnormal change is detected by monitoring distributions of deviations from the prediction ensemble, and
the prediction ensemble is corrected incrementally based on a real-time learning procedure, and
d) detecting an incident based on a result of step c).

2. The method according to claim 1, wherein, for detecting an the abnormal change, a Page-Hinkley test is used using as a cumulative variable defined as a cumulated difference between past observations and the mean of the past observations until the current moment.

3. The method according to claim 1, wherein the distributions use an allowed change parameter (ACP) representing a magnitude of an allowed change.

4. The method according to claim 3, wherein, for each system parameter, a corresponding ACP is used.

5. The method according to claim 1, wherein, for correcting, the prediction ensemble, a neuronal network. is used.

6. The method according to claim 5, wherein the neuronal network uses a delta rule procedure based on a back-propagation procedure for feed-forward neural networks.

7. The method according to claim 1, wherein one prediction procedure is based on an Autoregressive Integrated Moving Average (ARIMA) and an other prediction method is based on a Holt-Winters Exponential Smoothing (ETS).

8. The method according to claim 1, wherein the prediction ensemble is provided by weighted combining of results of the at least two at least two different prediction procedures.

9. The method according to claim 1, wherein the prediction ensemble is based on past observations within a certain time window, the time window sliding in time upon new observations.

10. The method according to claim 9, wherein at least wo different time windows having a different window size are used.

11. The method according to claim 1, wherein step c) includes reinitializing monitoring distributions of deviations from the prediction ensemble.

12. The method according to claim 1, wherein a filtering is performed for the predictions resulting in a single zero-one signal representing the incident.

13. The method according to claim 12, wherein the filtering is performed by comparing each of the predictions with a corresponding threshold and the incident is detected based on each of the predictions triggering the corresponding threshold.

14. The method according to claim 13, wherein additionally a correlation threshold between the at least two predictions has to be triggered to detect the incident.

15. A system for incident detection in a time-evolving system (TOS) comprising a plurality of objects moving in time and space along predefined paths, the system comprising one or more computation devices which, alone or in combination, are configured to provide for execution of the following steps:
a) providing predictions of at least two system parameters of the TOS by using for each prediction a different prediction procedure based on observations,
b) combining the at least two predictions to a prediction ensemble,
c) correcting the prediction ensemble based on an abnormal change of the system having occurred, wherein:
an abnormal change is detected by monitoring distributions of deviations from the prediction ensemble, and
the prediction ensemble is corrected incrementally based on a real-time learning procedure, and
d) detecting an incident based on a result of step c).

16. The system according to claim 15, wherein the objects include cars and the predefined paths include streets of a city,

17. The method according to claim 1, wherein the objects include cars and the predefined paths include streets of a city.

18. The method according to claim 5, wherein a Perceptron's neuron is used.
